(19) United States
(12) Patent Application Publication
(10) Pub. No.: US 2003/0028812 A1
(43) Pub. Date: Feb. 6, 2003

(54) Computer security during power-on self test

(76) Inventors: Paul Dennis Stultz, Round Rock, TX (US); Roger M. Blood, Austin, TX (US)

Correspondence Address: David L. McCombs, Haynes and Boone, LLP, 901 Main Street, Suite 3100, Dallas, TX, 75202-3789, US

(21) Appl. No.: 09/919,444

(22) Filed: Jul. 31, 2001

(51) Int. Cl. H04L 9/32

(52) U.S. Cl. 713/202

(57) ABSTRACT

A system and method of operating a computer system include ignoring all inputs from an input/output device during a power-on self test procedure except a pre-specified input; prompting a user for a password upon detection of the pre-specified input; comparing the password entered by the user in response to the prompting to a previously-stored password; and processing inputs other than the pre-specified input during the power-on self-test procedure if and only if the password entered by the user matches the previously-stored password. In one embodiment, the password must be entered by the user with a pre-specified period of time after the prompt.

### BACKGROUND OF THE INVENTION

1. Field of the Invention

The present invention relates to the field of computer system manufacturing and computer system operations. More specifically, this invention relates to providing computer system security.

2. Description of the Related Art

Computer systems have attained widespread use for providing computing power to many segments of today's modern society. A personal computer system can generally be defined as a desk top, floor standing, or portable microcomputer that includes a system unit having a system processor and associated volatile and non-volatile memory, a display monitor, a keyboard, one or more diskette drives, a fixed disk storage device and an optional printer. One of the distinguishing characteristics of these systems is the use of a system board to connect these components together electrically. These personal computer systems are information handling systems which are designed primarily to give independent computing power to a single user (or a group of users in the case of personal computers which serve as computer server systems) and are inexpensively priced for purchase by individuals or small businesses.

Personal computers and computers similar in capability to personal computers are more and more frequently used as servers. “Servers” includes computers running administrative software controlling access to a network and its resources. As used herein, “personal computer,” “computer,” “computer system,” and like terms include personal computer systems and like systems used as servers.

A personal computer system may also include one or more of a plurality of input/output (“I/O”) devices that are coupled to the system processor and perform specialized functions. As used herein, the terms “input/output device” and “I/O device” include but are not limited to modems, sound and video devices, controllers, specialized communication devices, mass storage devices such as hard disks, compact disk (“CD”) drives of many varieties, magneto-optical drives, other data storage devices, and remote terminals and processors that exchange information and data with a computer system, including exchanges over conductive means, e.g., telephone circuits, intranets, local area networks, and the Internet.

Computer systems generally contain information for which it is desirable to restrict access via I/O devices. Further, when a computer is acting as a server, restricted access is desirable to prevent unwanted impacts to network operations (inadvertent or intentional). Access may be restricted by means of hardware, i.e., by preventing the use of I/O devices, or by means of software, i.e., a program or routine that requires a valid password before access is allowed (“password lock”).

Generally, when a password lock is used, no communication between external devices and the secured computer is possible. While achieving the desired security, a password lock may also, in some implementations, prevent the operation of software that requires communication with the external devices that are locked out, i.e., software that must determine whether a particular external device is present to operate. One approach to this problem is set forth in U.S. Pat. No. 4,942,606, Computer With Improved Keyboard Password Functions, to Kaiser et al., (“Kaiser et al.”). Kaiser et al. is incorporated by reference herein in its entirety. Kaiser et al. describes a computer system having a “password lockout mode” for peripheral devices. During the password lockout mode, the affected peripheral devices are disabled, although the operating system software can continue to issue commands to and receive responses from otherwise disabled peripheral devices. Kaiser et al. discloses “[a] computer having an improved keyboard/auxiliary device interface controller which supports the selective restriction of user interaction with the computer system, while maintaining the full internal functionality of the host/peripheral interface. A ‘password lock mode’ of the improved controller prevents users from gaining unauthorized access to the computer system, but still application and operating system software can continue to issue commands to and receive responses from the otherwise disabled peripheral devices.” See Kaiser, abstract. “According to one embodiment of the . . . invention [of Kaiser], . . . the controller . . . is programmed to recognize certain commands and responses that should be allowed to pass between the main processor and a controlled device, even when the controller is in ‘password lock mode’. Normal user input from the controlled devices is still restricted however, except for the case of these selected command/response sequences. In this way, a user is still prevented from gaining unauthorized access to files or from disrupting the operation of a network server, but software which requires communication with external devices can still operate properly.” See Kaiser, col. 2, lines 24-36.

When a computer system is powered on, it generally executes a power-on self test (“POST”), during which it is desirable to restrict access to computer system files and to prevent unwanted impacts to computer operations. The POST is a set of routines that tests the computer system's components for proper connection and operation. During the POST procedure, communication is required between the external devices being tested and the computer system's processor. If the POST finds a problem, the computer generally alerts the user via aural and/or visual messages. If the POST is successful, it generally passes control to a bootstrap loader, which loads a larger loader program, which in turn loads the computer system's operating system.

Kaiser et al. teaches one method of securing a computer system by limiting input from a keyboard controller, while allowing activity such as the POST procedure to execute.

Existing systems and methods of providing computer security either halt the POST process while waiting for entry of a password by a user seeking to gain access to the computer system, and/or allow a user who has gained access to the computer system to reset the computer system, turn the power off, or alter the boot path by adding optional boot media such as floppy disks, compact discs-read only memory (“CD-ROMs”) or some item of virtual media.

What is needed is a method of providing computer security during POST that allows the boot (and/or re-boot) procedure to execute fully, while providing for authorized access to certain functions of a computer system during execution of the POST procedure.

Further, some existing systems and methods of providing computer security during the boot procedure, including during the POST procedure, require an authorized user's intervention, via, e.g., entry of a password, to permit and/or initiate the boot procedure itself.

What is needed is a system and method of providing computer security during the boot procedure, including the POST procedure, that permits a computer system to execute its boot procedure without requiring such intervention by an authorized user, including situations in which the computer system is rebooted or when power is interrupted or otherwise recycled. In addition, there exists a need for a technique to allow authorized access during the performance of a POST procedure.

### SUMMARY OF THE INVENTION

In accordance with the present invention, a system and method is presented for preventing a computer system user from using the computer system or otherwise interfering with the computer system's operations during the POST procedure, unless a particular access procedure is performed.

In a preferred embodiment, a computer system is presented which includes a processor; a memory coupled to the processor, the memory storing a pre-selected input, a first password, instructions causing the processor to compare a first input entered by the user to the pre-selected input, instructions causing the processor to ignore an input during a power-on self test procedure unless the first input matches the pre-selected input, instructions causing the processor to prompt a user of the computer system for a password if the processor receives the first input, instructions causing the processor to compare a password entered by the user to the first password, and instructions causing the processor to process inputs during the power-on self test procedure subsequent to the first input if the password entered by the user matches the first password. In one embodiment, the memory further stores instructions causing the processor to process inputs other than the first input if the password entered by the user is entered within a pre-specified period of time after the user is prompted.

In a preferred embodiment, a method of operating a computer system is presented which includes ignoring all inputs from an input/output device during a power-on self test procedure except a pre-specified input; prompting a user for a password upon detection of the pre-specified input; comparing the password entered by the user in response to the prompting to a previously-stored password; and processing inputs other than the pre-specified input during the power-on self-test procedure if and only if the password entered by the user matches the previously-stored password. In one embodiment, the password must be entered by the user with a pre-specified period of time after the prompt.

In a preferred embodiment, a computer program product is presented which includes a storage medium storing data and instructions operable to mask all inputs from an input/output device during a power-on self test procedure, except at least one input that corresponds to predetermined data, transmit a prompt for a password upon reception of an input that corresponds to the predetermined data, compare a password received from the input/output device to a qualified password, and accept and respond to other inputs from an input/output device during the power-on self test procedure if the received password conforms to the qualified password. In one embodiment, the password received from the input/output device is compared to the pre-specified password if received within a pre-specified period of time after the prompting.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a block diagram of an exemplary computer system.

FIG. 2 shows a flow chart of the execution of a basic input/output system (“BIOS”), including a power-on self test (“POST”) procedure.

FIG. 3 shows a flow chart of an embodiment of the invention.

### DETAILED DESCRIPTION

The following sets forth a detailed description of a mode for carrying out the invention. The description is intended to be illustrative of the invention and should not be taken to be limiting.

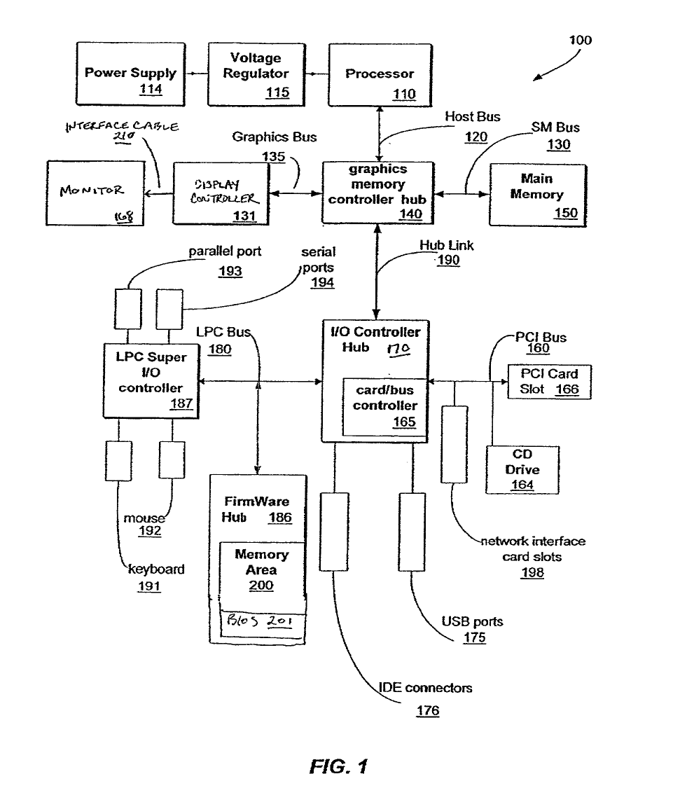

FIG. 1 is a block diagram of an exemplary computer system 100 that may be found in many forms, including, e.g., mainframes, minicomputers, workstations, servers, personal computers, internet terminals, notebooks, and embedded systems. Personal computer (“PC”) systems, such as those compatible with the x86 configuration, include desktop, floor standing, or portable versions. Exemplary computer system 100 includes a computer system hardware unit that further includes a microprocessor (or simply “processor”) 110, associated main memory 150, and a number of I/O devices for the exemplary computer system 100, and computer system software that runs on the hardware unit. Exemplary computer system 100 is powered by a power supply 114 with voltage regulator 115. The I/O devices often include keyboard 191, mouse-type input device 192, CD drive 164, and others not shown as included in the definition of I/O device, discussed above. The peripheral devices generally communicate with the processor over one or more peripheral component interconnect (“PCI”) slots 166, universal serial bus (“USB”) ports 175, or integrated device electronics (“IDE”) connectors 176. The PCI slots 166 may use a card/bus controller 165 to connect to one or more buses such as host bus 120, PCI bus 160, and low pin count (“LPC”) bus 180, with the buses communicating with each other through the use of one or more hubs such as graphics controller memory hub 140 and I/O controller hub 170. Typical systems such as exemplary system 100 often include network interface cabling slots 198 to accommodate network cards that mediate between the computer and the physical media over which transmissions to and from system 100 travel. The USB ports 175 and IDE connectors 176 may connect to one or more of the hubs 140, 170. The hubs may communicate with each other through the use of one or more links such as hub link 190. Many I/O devices can also be accommodated by parallel ports 193 and serial ports 194 that are coupled to an LPC super I/O controller 187 that is in turn coupled to a LPC bus 180. Typical computer systems often include a display controller 131 coupled to a graphics memory controller hub 140 by a graphics bus 135 and a main memory 150 coupled to a graphics memory controller hub 140 by a system management (“SM”) bus 130. Finally, a typical computer system also includes software modules known as the basic input/output system (“BIOS code”) 201. The BIOS code is either copied from an external medium such as a CD to, or stored on, the memory area 200 in firmware hub 186.

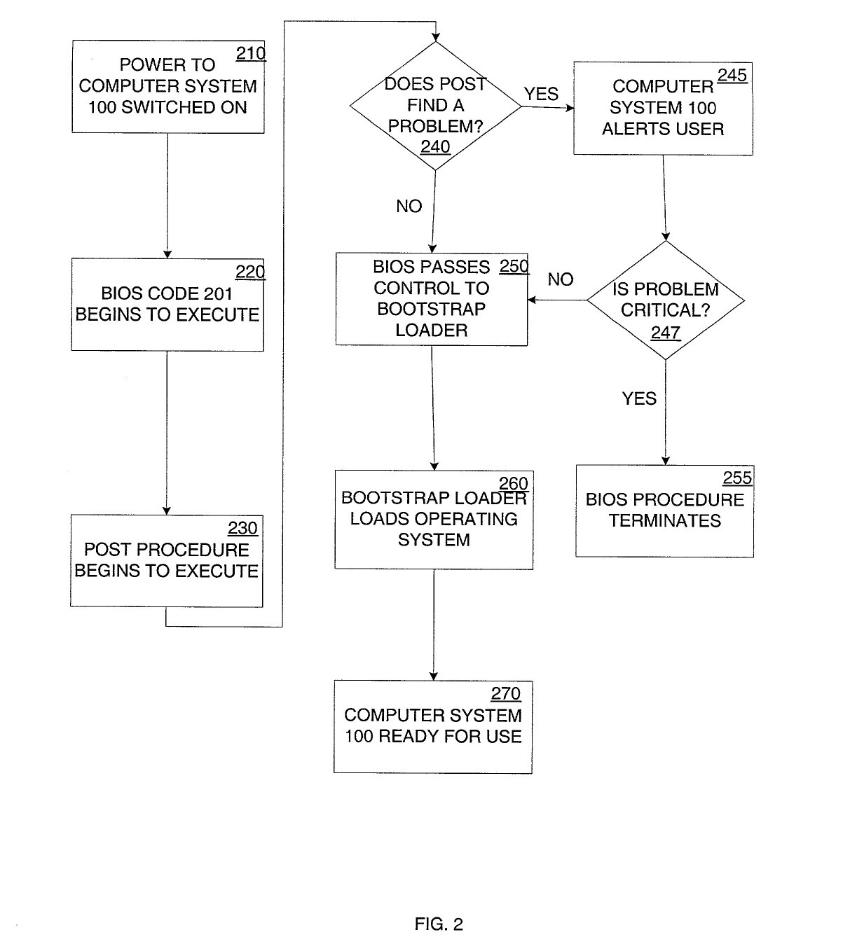

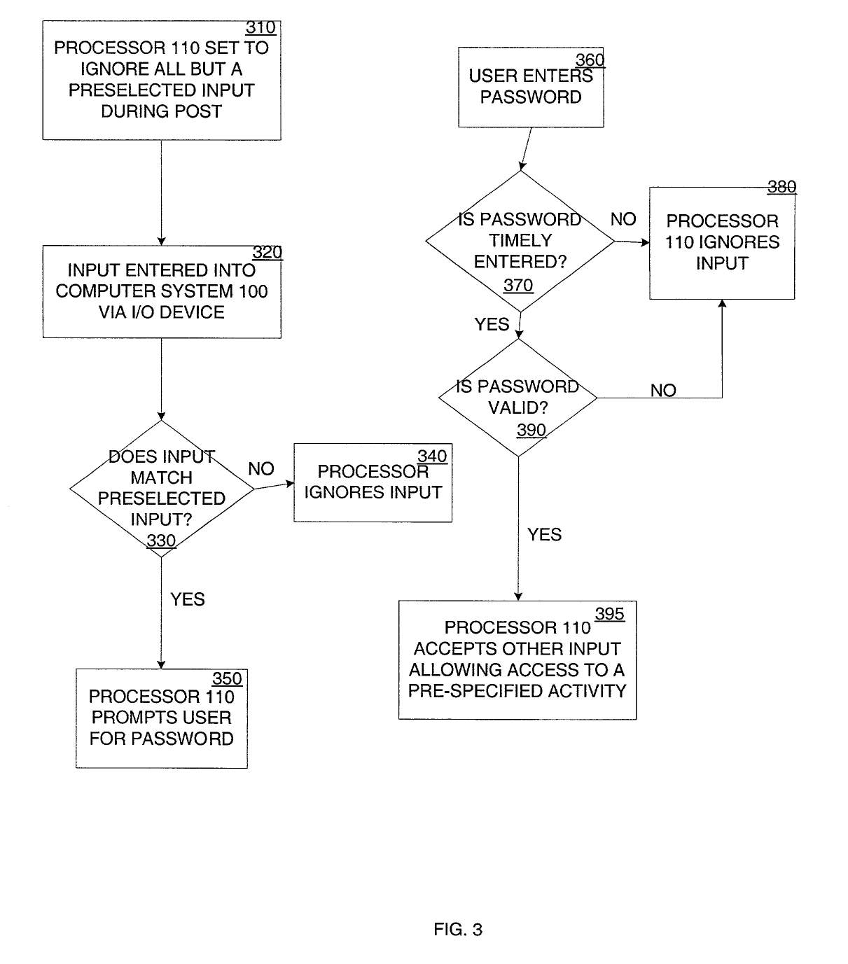

As used herein, the terms “input/output device” and “I/O device” include but are not limited to modems, sound and video devices, controllers, specialized communication devices, mass storage devices such as hard disks, compact disk (“CD”) drives of many varieties, magneto-optical drives, other data storage devices, and remote terminals and processors that exchange information and data with a computer system, including exchanges over conductive means, e.g., telephone circuits, intranets, local area networks, and the Internet. In the exemplary computer system 100 of FIG. 1, memory area 200 stores instructions and data for computer security during a power-on self test (“POST”) procedure, as described in connection with FIGS. 2 and 3 below.

It will be appreciated that a person skilled in the art will recognize that a computer system may be implemented in a variety of ways of which computer system 100 of FIG. 100 is merely an example and is not intended to be limiting.

FIG. 2 shows a flow chart of an exemplary technique for the execution of a basic input/output system (“BIOS”), including a POST procedure. It should be noted, however, that though the subject invention is useful in the context of BIOS execution, and particularly POST, specific aspects of BIOS, or POST, are not part of the invention. The invention is applicable to various versions of BIOS or POST performance. After the system's power is switched on (step 210), the BIOS code 201 begins to execute, providing for the preparation of computer system 100 for use (step 220). Some or all of the BIOS procedure is generally also executed if computer system 100 is re-booted without the power being switched off and then on again, but this feature is not shown in FIG. 2. Execution of the BIOS procedure generally includes the execution of a POST procedure (step 230). The POST procedure is a set of routines that tests the components of computer system 100 for proper connection and operation. If the POST finds a problem, computer system 100 generally alerts the user via aural and/or visual messages (steps 240 and 245). If the POST is successful, the BIOS procedure continues, passing control to a bootstrap loader (steps 240 and 250). If the problem is not critical to the operation of computer system 100, the BIOS procedure continues (steps 247 and 250). If the problem is critical to the operation of computer system 100, the BIOS procedure terminates (steps 247 and 255).

Continuing from step 250, the bootstrap loader in turn loads the operating system of computer system 100 (step 260). Once the operating system is loaded, computer system 100 is ready for use (step 270).

It will be appreciated that a person skilled in the art will recognize that BIOS and POST procedures may be implemented in a variety of ways of which the technique of FIG. 2 is merely an example and is not intended to be limiting.

FIG. 3 shows a flow chart of an embodiment of the invention. The invention presented advantageously allows a secure boot to operate in connection with devices other than an I/O controller (an example of which is illustrated in FIG. 1, the LPC super I/O controller 187), the other devices including, for example, Small Computer Systems Interface (“SCSI”) cards. Processor 110 is initially instructed to ignore all inputs except for a preselected input (step 310). In an aspect of this embodiment, processor 110 is initially instructed to ignore all inputs except for a pre-selected input from all I/O devices included in or coupled to computer system 100, including I/O devices coupled to computer system 100 remotely via, e.g., telephone circuits, intranets, local are networks, and the Internet.

Computer systems 100 often contain information for which it is desirable to restrict access via I/O devices. Further, when computer system 100 is acting as a server, restricted access is desirable to prevent unwanted impacts to network operations (inadvertent or intentional). The instructions for processor 110 to ignore all inputs from all I/O devices inputs except for a pre-selected input prevent unauthorized user access to one or more specific activities being performed or capable of being performed by computer system 100. These include, but are not limited to, prevention of entry into system setup and of ability the change system settings; prevention of ability to request special boot functions, such as utility partition booting; prevention of ability to halt or omit POST functions; prevention of ability to reboot computer system 100 (sometimes referred to as “soft reset”); prevention of ability to switch off power to computer system 100 (short of physically disconnecting computer system 100 from its power supply, such as by unplugging computer system 100 from its alternating current power supply); and prevention of entry by an unauthorized user into Option Read Only Memory (“OPROM”) utilities for SCSI and/or Redundant Array of Inexpensive Disks (“RAID”) controllers, and/or Network Interface Controllers (“NICs”), and/or virtual controllers that emulate controllers normally found within example computer system 100. (OPROM is the initialization code that is run during POST for SCSI and RAID controllers and for any bootable controller that is not directly supported by BIOS code to prepare the controller to be able to boot example computer system 100.)

An input is entered into computer system 100 by way of an I/O device (step 320). The I/O device used for entry of this input might be, e.g., a keyboard, and the entry may be performed, e.g., by way of a keystroke such as pressing the F2 key. If the input entered during the POST procedure does not match the pre-selected input as stored in processor 110 or in memory coupled to processor 110, processor 110 ignores the input (steps 330 and 340). In an aspect of the embodiment, key functions from a keyboard are masked in the keyboard interrupt service routine in the BIOS code. If the entered input matches the pre-selected input as stored in processor 110 or in memory coupled to processor 110, processor prompts a user of computer system 100 for a password (step 350). The user enters the password (step 360). In an aspect of the embodiment, if the entered password is not entered within a pre-specified period of time after processor 110 prompts the user, processor 110 continues to ignore input other than the pre-selected input (steps 370 and 380). If the entered password is entered within the pre-specified period of time after processor 110 prompts the user, but if the entered password does not match a password previously-stored for this purpose, processor 110 also continues to ignore input other than the pre-selected input (steps 390 and 380). If the entered password is entered within the pre-specified period of time, and if the entered password matches the previously stored password, processor 110 processes other inputs besides the pre-selected input (steps 390 and 395).

In an aspect of the embodiment, the inputs allowed to be processed by processor 110 as a result of the steps depicted in FIG. 3 may include, but are not limited to, inputs that -permit performance of one or more of the following activities: requesting special boot functions, such as utility partition booting; halting or omitting POST functions; rebooting computer system 100 (sometimes referred to as “soft reset”); switching off power to computer system 100 (short of physically disconnecting computer system 100 from its power supply, such as by unplugging computer system 100 from its alternating current power supply); entry into system setup and changing system settings; and entry into OPROM utilities for SCSI and/or RAID controllers, and/or NICs and/or virtual controllers that emulate controllers normally found within example computer system 100, allowing reconfiguration of the controller and its bootable media.

The specific choice of inputs allowed to be processed by processor 110 as a result of the steps depicted in FIG. 3, such inputs allowing specific functions to be performed by an authorized user, is a matter for the suppliers of an embodiment of the method and system of computer security during the POST procedure presented. Accordingly, any specific set of such allowed inputs is within the scope of the present invention. In an embodiment, an authorized user enters a password (in one aspect, within a pre-defined period of time) to gain access to the procedure that allows enablement and disablement and, once access is granted, enables or disables the method or system of computer security presented. In an aspect of the embodiment, the user who enables computer security is allowed to select the functions to which an authorized user will have access, and those to which access will be denied, when that authorized user completes the steps depicted in FIG. 3. These functions include, but are not limited to, those functions discussed above in connection with FIG. 2: prevention of entry into system setup and of ability the change system settings; prevention of ability to request special boot functions, such as utility partition booting; prevention of ability to halt or omit POST functions; prevention of ability to reboot computer system 100 (sometimes referred to as “soft reset”); prevention of ability to switch off power to computer system 100 (short of physically disconnecting computer system 100 from its power supply, such as by unplugging computer system 100 from its alternating current power supply); and prevention of entry by an unauthorized user into OPROM utilities for SCSI, and /or RAID controllers, and/or NICs and/or virtual controllers that emulate controllers normally found within example computer system 100.

It will be appreciated that a person skilled in the art will recognize that the system and method described in connection with FIG. 3 may be implemented in a variety of ways of which the steps illustrated in FIG. 3 are merely an example and is not intended to be limiting.

Other Embodiments

One skilled in the art will recognize that the foregoing components (e.g., steps), devices, and objects in FIGS. 1, 2, and 3 the discussion accompanying them are used as examples for the sake of conceptual clarity and that various configuration modifications are common. Consequently, as used herein the specific exemplars set forth in FIGS. 1, 2, and 3 and the accompanying discussion are intended to be representative of their more general classes. In general, use of any specific exemplar herein is also intended to be representative of its class, and the non-inclusion of such specific components (e.g., steps), devices, and objects herein should not be taken as indicating that limitation is desired.

While particular embodiments of the present invention have been shown and described, it will be obvious to those skilled in the art that, based upon the teaching herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims.

Other embodiments are within the following claims.

What is claimed is:

1. A computer system comprising:
a processor;
a memory coupled to the processor, the memory storing
a pre-selected input characteristic;
a stored password;
instructions causing the processor to compare a first input entered by the user to the pre-selected input characteristic;
instructions causing the processor to ignore an input during a power-on self test procedure unless the first input matches the pre-selected input characteristic;
instructions causing the processor to prompt a user of the computer system for a password when the first input matches the pre-selected input characteristic;
instructions causing the processor to compare a password entered by the user to the stored password; and
instructions causing the processor to process inputs during the power-on self test procedure subsequent to the first input when the password entered by the user matches the stored password.

2. The computer system of claim 1 wherein:
the memory further stores instructions causing the processor to process inputs other than the first input if the password entered by the user is entered within a pre-specified period of time after the user is prompted.

3. The computer system of claim 1 wherein:
the data corresponds to a keystroke on a keyboard.

4. The computer system of claim 3 wherein:
the data corresponds to an F2 key.

5. The computer system of claim 1 wherein:
the processing of inputs other than the first input enables the user to access a system setup procedure.

6. The computer system of claim 1 wherein:
the processing of inputs other than the first input enables the user to request boot functions.

7. The computer system of claim 1 wherein:
the processing of inputs other than the first input enables the user to reboot the computer system.

8. The computer system of claim 1 wherein:
the processing of inputs other than the first input enables the user to switch off a power supply of the computer system.

9. The computer system of claim 1 wherein:
the processing of inputs other than the first input enables the user to access an Option Read Only Memory utility.

10. The computer system of claim 1 wherein:
the processing of inputs other than the first input enables the user to halt a power-on self test function.

11. The computer system of claim 1 wherein:
the processing of inputs other than the first input enables the user to omit a power-on self test function.

12. A method of operating a computer system comprising:
ignoring all inputs from an input/output device during a power-on self test procedure except a pre-specified input;
upon detection of the pre-specified input, prompting a user for a password;
comparing the password entered by the user in response to the prompting to a previously-stored password; and
processing inputs other than the pre-specified input during the power-on self-test procedure if and only if the password entered by the user matches the previously-stored password.

13. The method of claim 12 wherein:
the comparing is performed if and only if the password entered by the user is entered within a pre-specified period of time after the prompting.

14. The method of claim 12 wherein:
the pre-specified input is generated by a keystroke on a keyboard.

15. The method of claim 14 wherein:
the keystroke is a pressing of an F2 key.

16. The method of claim 12 wherein:
the processing gives a user access to a system setup procedure.

17. The method of claim 12 wherein:
the processing gives a user an ability to request boot functions.

18. The method of claim 12 wherein:
the processing gives a user an ability to reboot the computer system.

19. The method of claim 12 wherein:
the processing gives a user an ability to switch off a power supply of the computer system.

20. The method of claim 12 wherein:
the processing gives a user an ability to access an Option Read Only Memory utility.

21. The method of claim 12 wherein:
the processing gives a user an ability to halt a power-on self test function.

22. The method of claim 12 wherein:
the processing gives a user an ability to omit a power-on self test function.

23. A computer program product comprising a storage medium storing data and instructions operable to:
mask all inputs from an input/output device during a power-on self test procedure, except at least one input that corresponds to predetermined data;
upon reception of an input that corresponds to the predetermined data, transmit a prompt for a password;
compare a password received from the input/output device to a qualified password; and
if the received password conforms to the qualified password, accept and respond to other inputs from an input/output device during the power-on self test procedure.

24. The computer program product of claim 23 wherein:
the masking masks from a processor the inputs from an input/output device during power-on self test; and
the reception of the input that corresponds to the predetermined data is performed by the processor.

25. The computer program product of claim 23 wherein:
the comparing compares a password received from the input/output device that is received within a pre-specified period of time after the prompting.

26. The computer program product of claim 23 wherein:
the accepting and responding to other inputs enables the user to access a system setup procedure.

27. The computer program product of claim 23 wherein:
the accepting and responding to other inputs enables the user to request boot functions.

28. The computer program product of claim 23 wherein:
the accepting and responding to other inputs enables the user to reboot the computer system.

29. The computer program product of claim 23 wherein:
the accepting and responding to other inputs enables the user to switch off a power supply of the computer system.

30. The computer program product of claim 23 wherein:
the accepting and responding to other inputs enables the user to access an Option Read Only Memory utility.

31. The computer program product of claim 23 wherein:
the accepting and responding to other inputs enables the user to halt a power-on self test function.

32. The computer program product of claim 23 wherein:
the accepting and responding to other inputs enables the user to omit a power-on self test function.
